(19) United States
(12) Patent Application Publication
(10) Pub. No.: US 2018/0151950 A1
(43) Pub. Date: May 31, 2018

(54) ANTENNA MOUNTING BRACKET WITH AIR DEFLECTING CURVATURE

(71) Applicant: THOMSON Licensing, Issy-les-Moulineaux (FR)

(72) Inventors: Mickey Jay HUNT, Camby, IN (US); Julianne Luna SO, Fishers, IN (US); Darin Bradley RITTER, INDIANAPOLIS, IN (US)

(21) Appl. No.: 15/567,170

(22) PCT Filed: Sep. 17, 2015
(86) PCT No.: PCT/US15/50606

§ 371 Date: Oct. 17, 2017

Related U.S. Application Data
(60) Provisional application No. 62/150,056, filed on Apr. 20, 2015.

(51) Int. Cl. H01Q 1/42; H04B 1/08; H01Q 1/38; H01Q 1/02; H01Q 1/22; H01Q 13/18; H01Q 1/00; H01Q 1/12; H01Q 21/28

(52) U.S. Cl. CPC H01Q 1/42; H04B 1/08; H01Q 1/38; H01Q 1/02; H01Q 21/28; H01Q 13/18; H01Q 1/007; H01Q 1/1214; H01Q 1/22

(57) ABSTRACT

A device is provided for vertical orientation during operation, that includes a plurality of vertically oriented walls, an antenna bracket having sides that support antennas which extend from corners of the antenna bracket, at least one of the sides of the antenna bracket having a curved profile, the curved profile comprising a U-shape cross section with an open end facing downward. The device further includes a horizontally oriented fan positioned closer to a base of the device than to a top of the device. The fan is positioned below the antenna bracket and is oriented to force air upward and into the interior half of the U-shape cross section, the U-shape cross section directing some upwardly directed air to travel downward between interior components of the device that are adjacent to the vertically oriented walls.

### CROSS-REFERENCE TO RELATED APPLICATIONS

This application claims the benefit of U.S. Provisional Application Ser. No. 62/150,056, filed Apr. 20, 2015, which is incorporated by reference herein in its entirety.

### FIELD

The present principles relate to electronic devices and antenna mounting arrangements within electronic devices and heat management therein.

### BACKGROUND

Electronic devices such as set-top boxes are typically assembled apparatuses having a plurality of walls and other components. These other components can include printed circuit boards, heat sinks or heat spreader, wires, hard drives, smart card assemblies, and antennas. The plurality of walls and components make the assembly of these devices quite challenging in high volume manufacturing environments. As such, there is a need to insure that the components are staged, mounted, and installed in a manner that is fast and safe for the components. Further, there is a need to insure that the components are inspectable and designed in a manner that makes their installation as reversible as possible for rework in the factory or in the field.

As such, some devices such as the vertically oriented set top box disclosed in International Application No. PCT/US15/17791 filed on Feb. 26, 2015 incorporate screwless attachment concepts to assemble the housings of the devices in such a way that the access to the devices in the field can be performed in a safe efficient manner by an authorized person without the need to undue screws. Such designs as in the above mentioned application make gaining access to the interior components of these devices more convenient and reduce excessive handling.

The casings of the vertically oriented set top boxes and gateway devices are relatively tall. The bases are generally narrow. With such a geometry, these designs present more challenges than the horizontally oriented set top boxes for screwless housing assembling. The reason is it is difficult to include a locking mechanism in these tall boxes that can extend from the top side to the bottom side of the boxes and yet still be able to house the plurality of necessary components which can include a plurality of antennas without interfering with the locking mechanism.

The need for a plurality of antennas in these vertically oriented set top boxes or gateway devices particularly presents a challenge. The problem is that in some designs up to 7 antennas are required, which means that additional wires must be used to connect the antennas to a circuit board and additional fixtures or antenna supports must be installed in the devices to support the antennas. Further, the antennas not only involve extra handling of the work product in the factory that place other components at risk and drive up manufacturing cost, but also these antennas have a propensity for electrostatic discharge in use. As such, designers must ensure that the antennas are adequately shielded in these devices which tend to be quite crowded. Thus, the need exists for an antenna mounting system that is commensurate with the screwless attachment concepts and yet do not pose the risk of electrostatic discharge to and from the antennas.

An additional issue in these crowded vertically oriented electronic devices is the implementation of a heat management system. As such, there is a need for such a system that can appropriately spread, dissipate and/or expel heat and yet not interfere with the interior components and the locking mechanism. A further requirement is for the heat management system to not require a substantial increase in the interior volume of the device.

These and other drawbacks and disadvantages presented by vertically oriented electronic devices are addressed by the present principles, which are directed to a vertical electronic apparatus and associated printed circuits. However, it can be understood by those skilled in the art that the principles can be taken advantage of in horizontally oriented devices as well.

### SUMMARY

According to the present principles, an electronic device 200 is provided that comprises a plurality of vertically oriented walls 204, 206, 208, a plurality of antennas 602 among which at least one of the antennas is positioned adjacent to a first wall of the vertically oriented walls and at least one of the antennas is positioned adjacent to a second wall of the vertically oriented walls, and a curved antenna bracket 601. The curved antenna bracket can be a closed polygonal structure having at least two sides 603 that support the antennas that each extends from corners of the bracket. At least one of the sides of the antenna bracket can be a curved side that has a curved profile. The at least one curved side is positioned adjacent to a corresponding one of the vertically oriented walls, the vertically oriented walls being planar. The at least one curved side can be vertically oriented along a corresponding one of the vertically oriented walls. The at least one curved side can be bowed from a top plan view perspective to have a concave side facing the corresponding vertically oriented wall of the electronic device. The electronic device can further comprise a plurality of antenna connectors 606 positioned away from the antenna bracket and configured to connect with a plurality of antenna wires 604 extending from each of the antennas. The electronic device can include a vertically oriented printed circuit board 501 positioned at least partially below the antenna bracket such that the antenna connectors are positioned adjacent to a top edge of the printed circuit board. The curved profile can comprise a U-shape cross section with an open end facing downward. The electronic device can include a horizontally oriented fan 231 positioned closer to a lower edge of the printed circuit board than the top edge of the printed circuit board. The fan can be oriented to force air upward and through a hollow center region of the curved antenna bracket. The horizontally oriented fan 231 can be positioned closer to a base 205 of the electronic device than to a top 210 of the electronic device and below the antenna bracket. The fan can be oriented to force air upward and through the hollow center region of the curved antenna bracket and into at least the interior half of the U-shape cross section. The electronic device can comprise vents 233 in at least one of the vertically oriented walls and some of the vents can be at the same vertical height as the antenna bracket. Some of the air through the hollow center region of the curved antenna bracket can be redirect by or at a top 210 of the electronic device to pass over the sides of the antenna bracket and downward along the vertically oriented walls and outward through the vents. The U-shape cross section can cause some upwardly directed air to travel downward between interior components of the electronic device that are adjacent to the at least one of the vertically oriented walls and to travel outward through at least some of the vents. The electronic device can be a vertically oriented set top box or a vertically oriented gateway device. A horizontally oriented partition 238 can be provided and positioned above or at the level of the fan to create a high pressure region above the partition and a low pressure region below the partition. The vents in at least one of the vertically oriented walls below the partition can permit cooling air to enter the electronic device therethrough and the vents positioned above the partition can permit heated air to exit the electronic device therethrough. A heat generating electronic component 232 can be positioned above the fan and below the antenna bracket.

### BRIEF DESCRIPTION OF THE DRAWINGS

The present principles can be better understood in accordance with the following exemplary figures, in which:

FIG. 1 is a perspective view of a vertically oriented electronic device 200 to which the current principles are applied;

FIG. 2 is a disassembled perspective view of the vertically oriented electronic device 200;

FIG. 3 is a perspective view of a retention clip 214;

FIG. 4 is a perspective view of the casing that shows how the pieces of the casing are assembled;

FIG. 5 is a perspective view of the casing that shows a case back retaining element;

FIG. 6 is a perspective view of the casing that shows a cross-section of an interlock;

FIG. 7 is a perspective view of the casing that shows an opening on the case front;

FIG. 8 is a perspective view of the retaining elements of the vertically oriented electronic device 200;

FIG. 9 is another perspective view of the retaining elements of the vertically oriented electronic device 200;

FIG. 10 is a disassembled perspective view of the vertically oriented electronic device 200;

FIG. 11 is a bottom perspective view of the vertically oriented electronic device 200 and the retention clips 214;

FIGS. 12-14 are various views of the retention clips 214;

FIG. 15 is a perspective view of the case bottom piece 213;

FIGS. 16 and 17 are perspective views showing how the bottom piece 213 engages the case top front piece and the case top back piece;

FIG. 18 is a bottom perspective view of the vertically oriented electronic device 200;

FIG. 19 is a view of the release fixture 300;

FIG. 20 is a flow diagram showing an exemplary method 2100 for assembling an electronic device having a case bottom piece, a case top front piece, and a case top back piece, commensurate with an embodiment of the present principles;

FIG. 21 is a flow diagram showing an exemplary method 2200 for disassembling an electronic device having a case bottom piece, a case top front piece, and a case top back piece, commensurate with an embodiment of the present principles;

FIGS. 22-25 show perspective views of circuit board assembly configuration 500 to which the current principles are applied;

FIG. 26 is a perspective view of the circuit board assembly configuration 500 highlighting the connector 503 to which the current principles are applied;

FIGS. 27-28 are interior perspective views of the vertically oriented electronic device 200 showing the circuit board assembly configuration 500 to which the current principles are applied;

FIG. 29 is a flow diagram showing an exemplary method 4800 for assembling an electronic device having a case bottom piece, a case top front piece, and a case top back piece to which the current principles are applied;

FIG. 30 shows a rear perspective view of the set top box without the case, in which a plurality of antennas 602 are distributed over the circuit boards 501 and 502;

FIG. 31 shows various perspective interior views of the rear wall 206 with different components thereon to which the current principles are applied;

FIG. 32 shows a perspective view of a single unitary antenna bracket 601 that supports the plurality of antennas 602 within the electronic device according to the current principles;

FIG. 33 shows a rear perspective view of the antenna bracket 601 in relation to the circuit board 501 according to the current principles;

FIG. 34 shows various perspective views of the antenna bracket 601 and the pocket 605 therein which support the antennas 602 according to the current principles;

FIG. 35 shows a perspective view of the antenna bracket 601 and the antenna wires 604 routed to one bracket wall 603 according to the current principles;

FIG. 36 shows a perspective view of the antenna bracket 601 and the antenna wire 604 routed to one bracket wall 603 and toward the first printed circuit board 501 on the rear wall 206 of the electronic device according to the current principles;

FIG. 37 shows a rear perspective view of the antenna bracket 601 and the antenna wires 604 routed to one bracket wall 603 and down to the first printed circuit board 501 according to the current principles;

FIG. 38 shows a heat management feature involving a fan and a curved antenna bracket 601;

FIG. 39 shows an magnified top view of a portion of the antenna bracket 601; and

FIG. 40 shows views of the electronic device that highlight heat management features according to the current principles.

### DESCRIPTION OF EMBODIMENTS

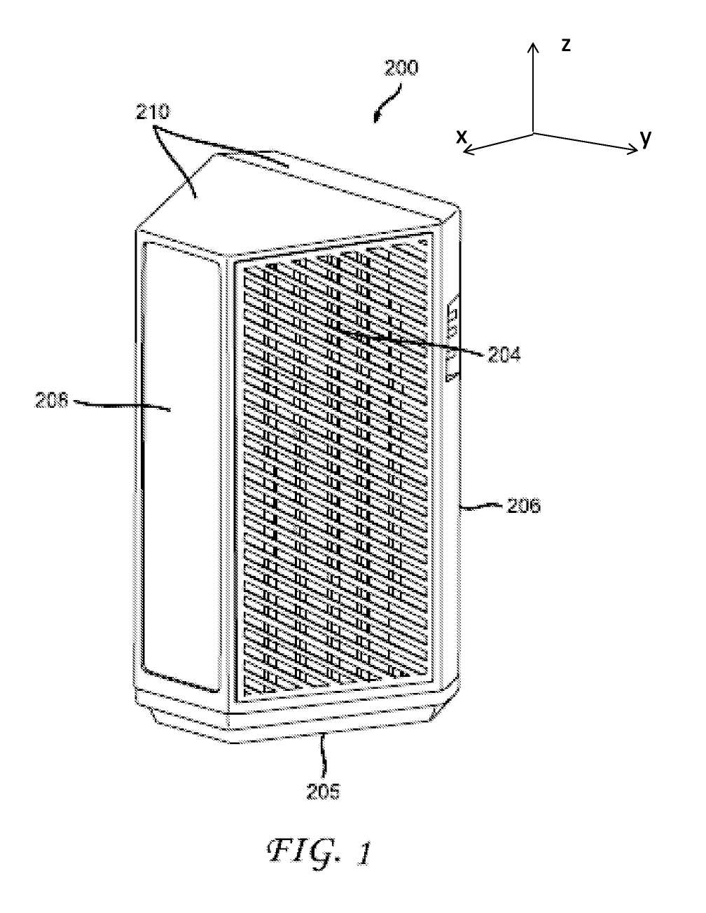

FIG. 1 shows a perspective view of a vertically oriented electronic device 200 that houses an antenna bracket 601 and antennas 602. The device can include a top 210, a front wall 208, a rear wall 206, side walls 204, and a base 205.

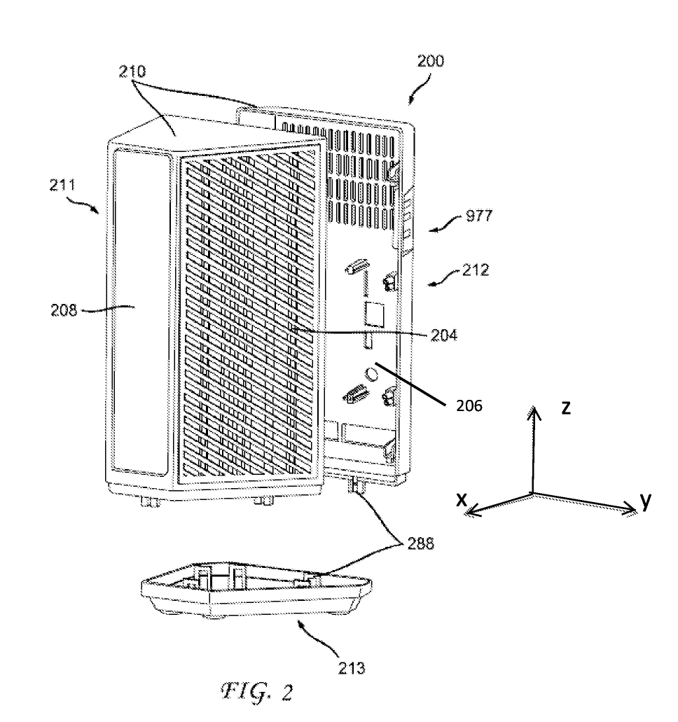

FIG. 2 shows the three principal pieces of the vertically oriented electronic device 200. The three pieces are the case bottom piece 213, the case top front piece 211, and the case top back piece 212. The case top front piece 211 and the case top back piece 212 are upper parts of the device 200.

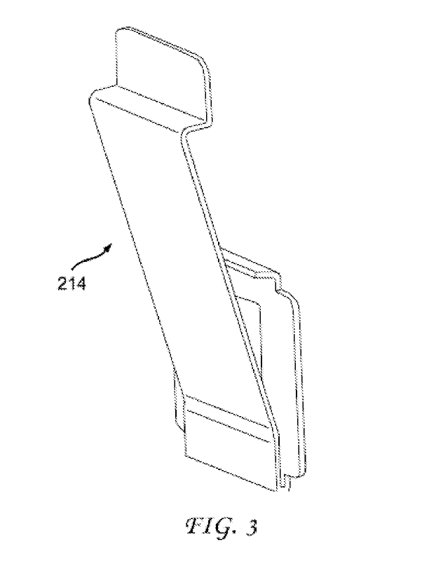

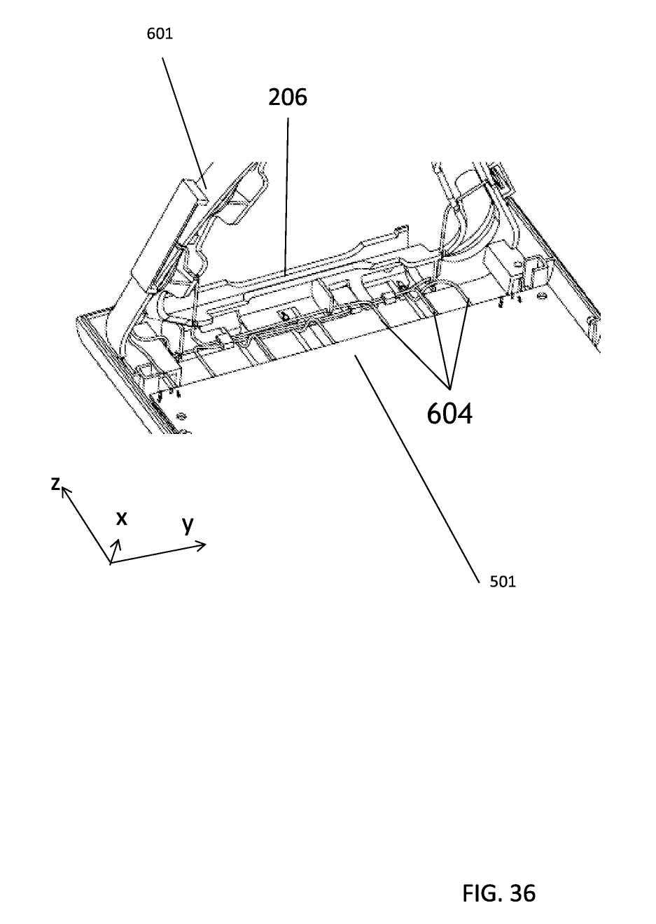

FIG. 3 is a perspective view of a retention clip 214 which can be optionally composed of metal and is utilized to engage and secure the case bottom piece 213 to the case top front piece 211 and/or the case top back piece 212. The retention clip 214 is positioned toward the bottom of the electronic device and is a key part of the locking mechanism applied on the electronic device. By having the retention clip 214 at the bottom, the antenna bracket 601 and the antennas 602 can be positioned at the other end of the electronic device; hence, the antenna bracket 601 (shown in FIG. 36 at the top end of the rear wall 206) and the antennas 602 do not interfere with locking and/or unlocking of the electronic device. Additionally, the use of the retention clip 214 in concert with other features to be described permits easy access to the antenna bracket 601 and the antennas 602 when needed. The retention clip 214 can be part of a screwless locking mechanism positioned adjacent to the base 205 of the electronic device and can be remote from the antennas in the antenna bracket 601, especially when they are positioned adjacent to the top 210.

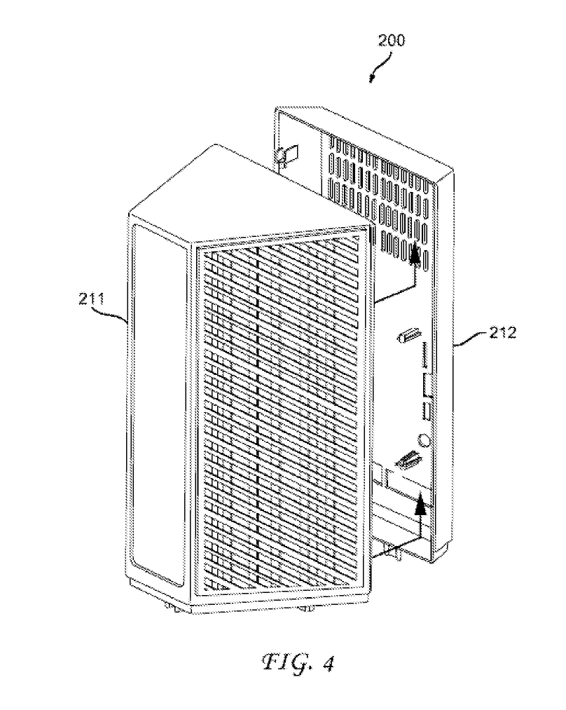

FIG. 4 shows how the case top front piece 211 is slid back onto the case top back piece 212 of the electronic device 200, and then up into retaining elements in order to lock the two pieces together such that internal electronic components can be housed therein when the assembly is finalized.

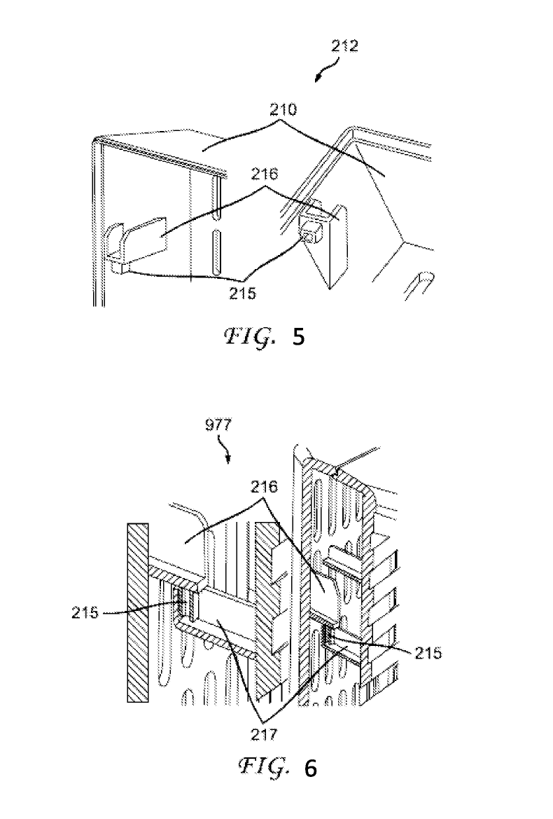

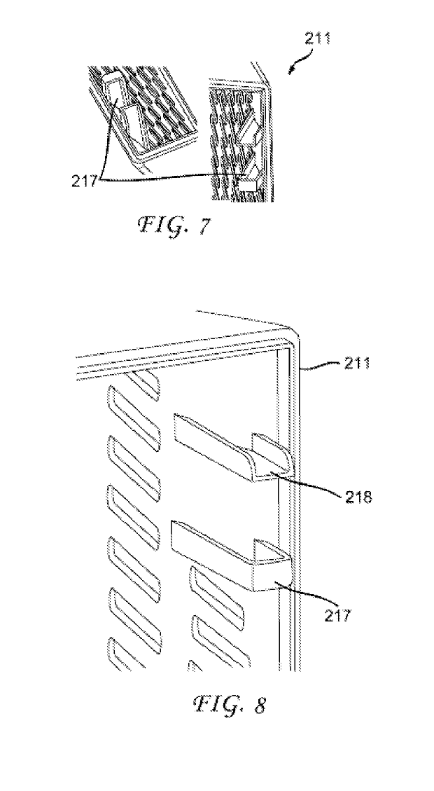

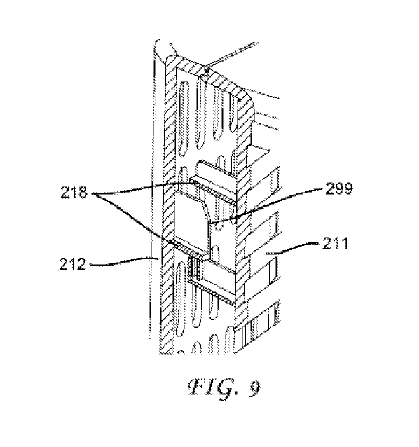

FIGS. 5-7 show the specific engagement mechanism 215, 216, 217 to which the current principles are applied. A protruding ledge 216 extends inwardly from the interior surface of one of the vertical walls of one of the pieces. The protruding ledge 216 includes a protrusion 215 that engages a protrusion receiving opening 217 on the case top front piece 211. The protrusion receiving openings 217 are generally horizontal ledges that have upstanding peripheral walls to make a slot that can receive the protrusions 215. The slots can be oversized in the dimension that is perpendicular to the interior surfaces of the vertical walls from which the horizontal ledge extends, or the slots can be oversized along its long lateral axis. The slot can be narrow along the dimension parallel to the vertical walls or along the horizontal ledge's short lateral axis to snuggly fix the protrusions 215. The protruding ledge 216, the protrusions 215, and the protrusion receiving openings 217 form a screwless engagement structure 977. The arrangement of the protruding ledges 216 and the protrusions 215 can be spaced from the interior top surface of the case top 210 to permit the antenna bracket 601 and the antennas 602 to be positioned at a lateral level between the interior top surface of the case top 210 and the protruding ledges 216 and the protrusions 215. This permits the antenna bracket 601 and the antennas 602 from interfering with the locking and/or unlocking the pieces of the electronic device. FIGS. 8 and 9 show further perspective views of the retaining elements that are used to engage the case top front piece 211 with the case top back piece 212. FIG. 8 shows ribs 218 that are positioned above the protrusion receiving openings 217 and also extend inwardly from the interior surface of one of the vertical walls of the front piece 211. The ribs 218 would interfere with the case rear retention element if an assembly start position is attempted that is too low. FIG. 9 shows that a chamfer 299 guides the case top 210 to an acceptable start location. Rib 218 prevents case front from starting in a position that is too low by preventing excessive case travel which can damage components.

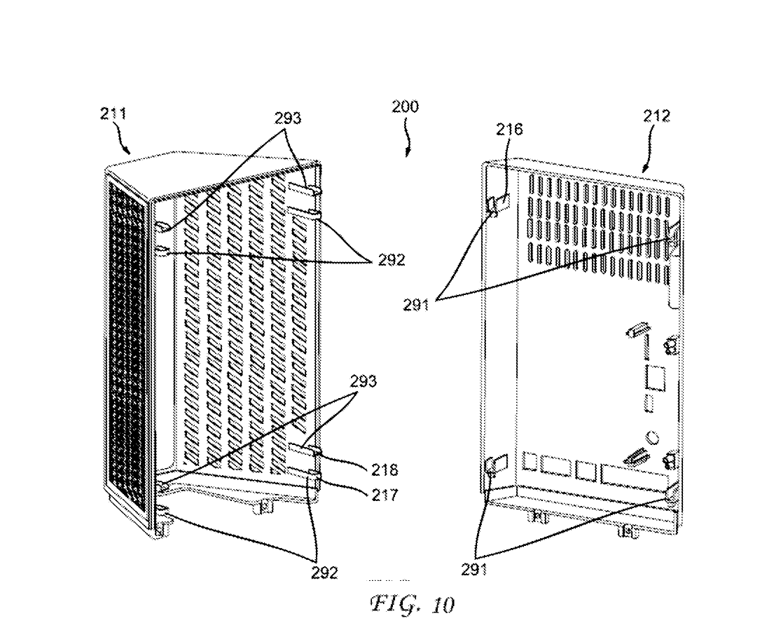

FIG. 10 is a disassembled perspective view of the vertically oriented electronic device 200 showing the interior of the case top front piece 211 and the case top back piece 212 of the electronic device 200 to which the current principles are applied. The retention protrusions 291, the retention openings 292, and the over travel prevention portions 293 are shown in FIG. 10.

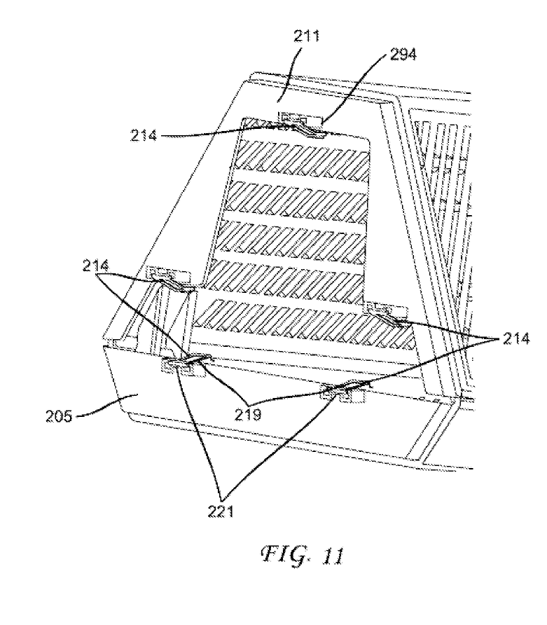

FIG. 11 is a bottom perspective view of the vertically oriented electronic device 200 in which the case bottom piece 213 is not attached.

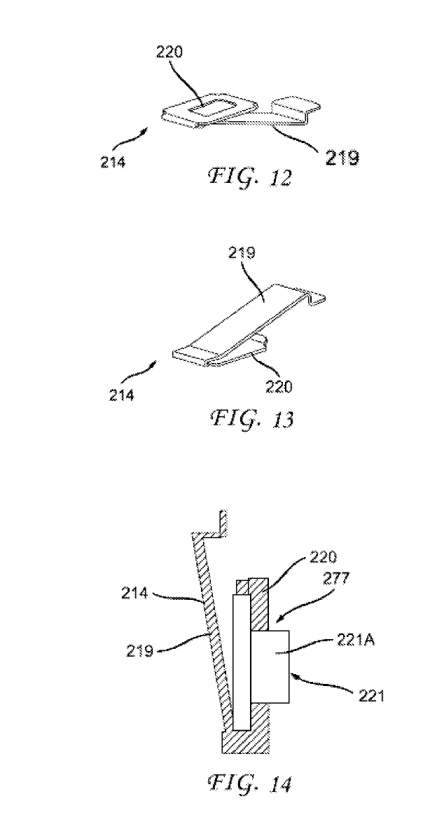

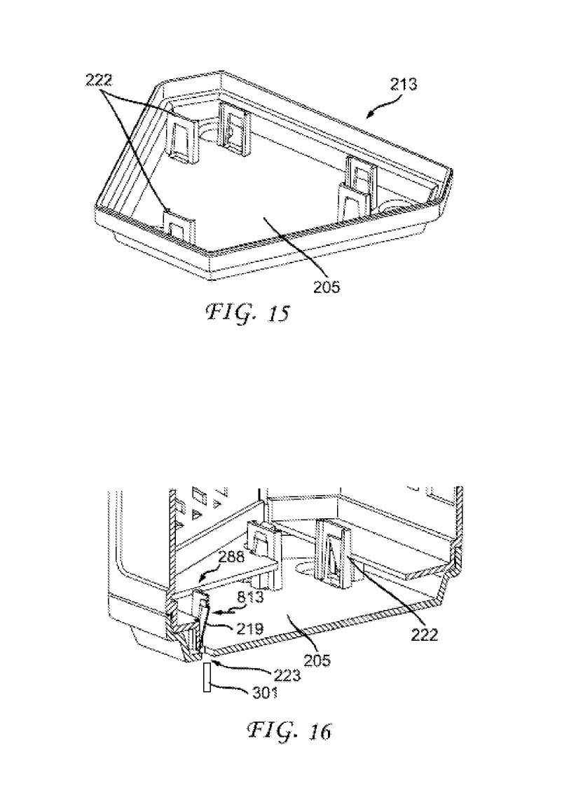

FIGS. 12-14 are various views of the retention clip 214 to which the current principles are applicable. The retention clip 214 can be optionally composed of metal. The views show that the case top front piece 211 and the case top back piece 212 can be attached to one another and can then be attached to the case bottom piece 213 using the retention clips 214. The retention clips 214 are retained by elements on the case top front piece 211 and the case top back piece 212. The clip 214 is generally V-shape and includes an anchor portion 220 which is one side of the V-shape. The anchor portion 220 has a rectangular planar shape and has an aperture 277 that fits into an anchor base 221 of the case top front piece 211 and the case top back piece 212. FIG. 14 shows how the aperture 277 of the anchor portion 220 engages a protrusion 221A in the anchor base 221 such that an inward pointing ledge at the top of the anchor portion 220 grasps a top portion of the anchor base 221 and a bottom inner wedge grasps the bottom portion of the anchor base 221 to secure the retention clip 214. This permits a locking portion 219 of the clip 214, which is the other side of the V-shape, to engage with elements of the case bottom piece 213 to close or assemble the electronic device 200. In particular, referring to FIGS. 15-16, the top of the locking portion 219 can have a horizontal ledge that extends inwardly to contact a bottom surface of a clip engaging element 222. The locking portion 219 can further have an upward extension at the edge of the horizontal ledge to engage an edge of the bottom surface of the clip engaging element 222. As shown in 17, the outward spring force of the clip 214 causes the locking portion to move outward to engage the element 222. Although a V-shape is shown, a U-shape could be employed as well and both sides of the V or U-shape part can have different heights. The retention clip 214 and the engaging elements 222 can be part of a screwless locking mechanism positioned adjacent to the base 205 of the electronic device and can be remote from the antennas in the antenna bracket 601 which can be positioned adjacent to the top 210 of the electronic device.

FIG. 15 is a perspective view of the case bottom piece 213, which shows the base 205 and the clip engaging elements 222 that extend vertically upward from the bottom piece 213 to which the current principles are applied. The clip engaging elements 222 are designed to engage the locking portion 219 of the clips 214 on the case top front piece 211 and the case top back piece 212. A screwless clip and spring mechanism 288 is formed from the clips 214 and the clip engaging elements 222.

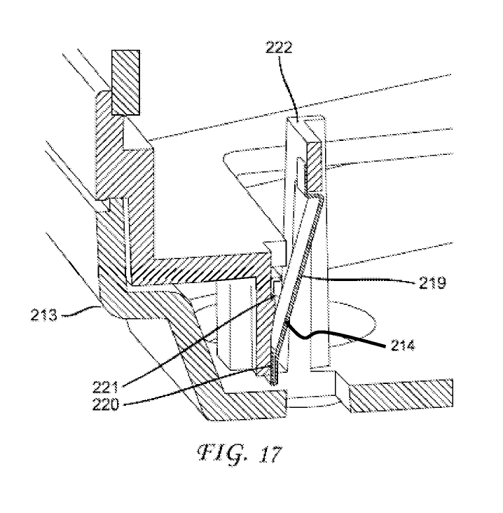

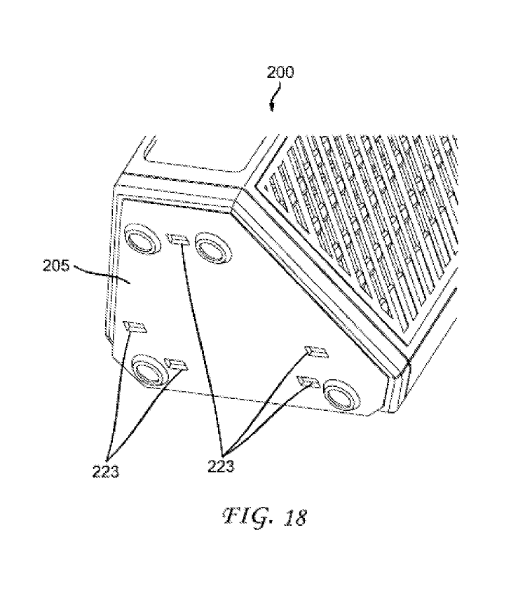

FIGS. 16 and 17 are perspective views showing how the case bottom piece 213 engages the case top front piece 211 and the case top back piece 212 to which the current principles are applied. Release finger 301 pushes the locking portion 219 inward to disengage the locking portion 219 as it enters an aperture 223.

FIG. 18 is a bottom perspective view of the vertically oriented electronic device 200 to which the current principles are applicable. The reason is that the apertures 223 for the unlocking are remote from the antenna bracket 601 and the antennas 602.

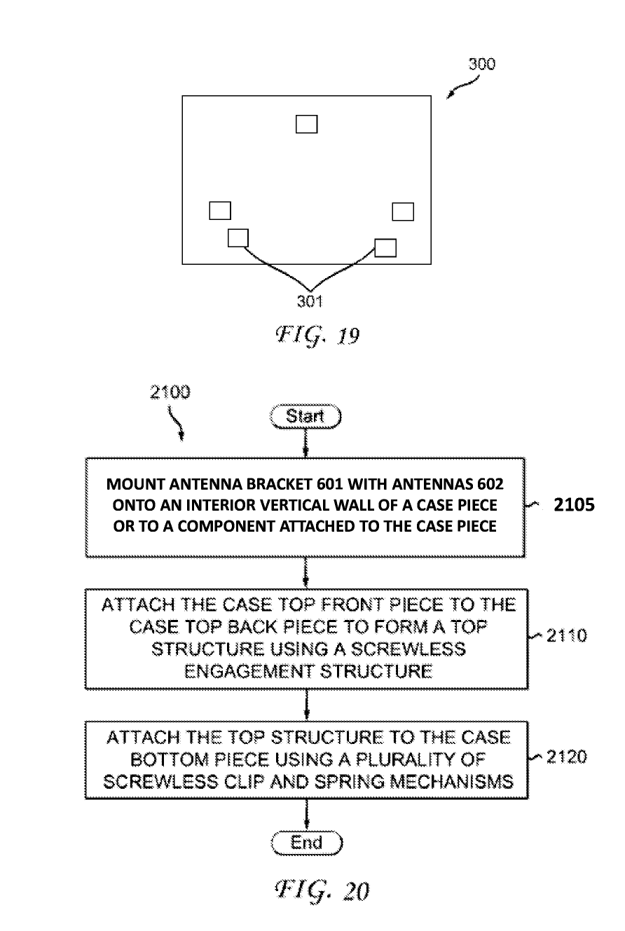

FIG. 19 is a view of a release fixture 300 to which the current principles are applied. FIGS. 16-19 show the release aperture 223 in base 205. A release finger 301 on a base of a release fixture 300 is permitted to enter the release aperture 223 to push the locking portion 219 inward toward the anchor portion 220, thereby removing the top portion of the locking portion 219 from the engaging element 222. This can be understood also with reference to FIG. 18 in which the release finger 301 (not shown in FIG. 18) will contact the outer edge of the locking portion 219 and move the locking portion 219 away from the engaging element 222.

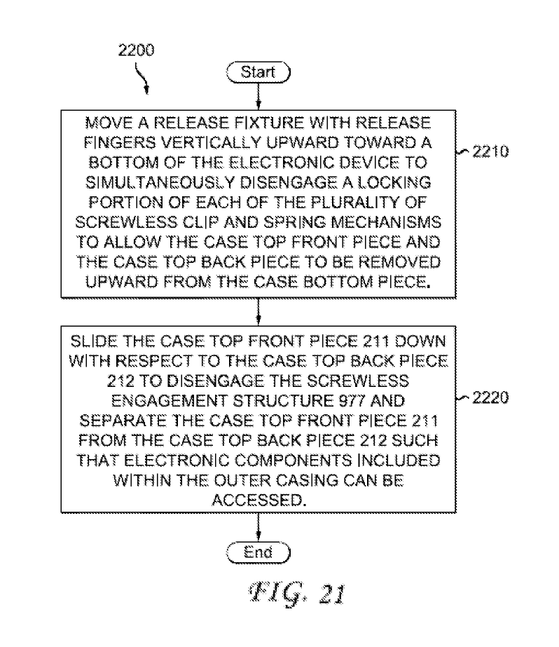

FIG. 20 is a flow diagram showing an exemplary method 2100 for assembling an electronic device having a case bottom piece, a case top front piece, a case top back piece, an antenna bracket and antennas mounted therein. Here, at step 2105, the antenna bracket 601 is mounted onto an interior vertical wall of the case top front piece or case top back piece or mounted to a component that is mounted to the interior vertical wall of the case top front piece or case top back piece. The antenna bracket 601 can be a curved antenna bracket which will be described below. At step 2110, the case top front piece 211 is attached to the case top back piece 212 to form a top structure 210 using a screwless engagement structure 977. At step 2120, the top structure 210 is attached to the case bottom piece 213 using a plurality of screwless clip and spring mechanisms 288.

FIG. 21 is a flow diagram showing an exemplary method 2200 for disassembling an electronic device having a case bottom piece, a case top front piece, and a case top back piece having the antenna bracket 601 mounted therein. The method 2200 is applied to an assembled condition, wherein the case top front piece is attached to the case top back piece 212 to form a top structure 210 using a screwless engagement structure 977, and the top structure is attached to the case bottom piece using a plurality of screwless clip and spring mechanisms 288. At step 2210, a release fixture 300 is moved vertically upward to cause the release fingers 301 to also move vertically upward toward a bottom of the electronic device to simultaneously disengage a locking portion 219 of each of the plurality of screwless clip and spring mechanisms 288, thereby allowing the case top front piece 211 and the case top back piece 212 to be removed upward from the case bottom piece 213. At step 2220, the case top front piece 211 slides down with respect to the case top back piece 212 to disengage the screwless engagement structure 977 and separate the case top front piece 211 from the case top back piece 212 such that electronic components included within the electronic device can be accessed.

The electronic device 200 can be a set-top box or the like and can be vertically oriented such that the height of the device is higher than the width of the front vertical surface and/or the rear vertical surface and/or the lateral depth. The lateral cross section can be a quadrilateral shape in which the front and back are parallel and the side surfaces are not parallel to one another. The device can be designed such that the release fixture and release fingers move vertically upward toward the bottom of the device to simultaneously disengage the plurality of the locking portions to allow the case top front piece 211 and the case top back piece 212 to be remove upward from the case bottom piece 213. The case top front piece 211 and the case top back piece 212 can then further be detached from one another by moving the case top in a motion oppose to that shown in FIG. 5 to attach the two pieces (case top front piece 211 and case top back piece 212). With the two pieces 211 and 212 attached, the assembly can be reassembled or assembled by aligning the clip engaging elements 222 with the clip 214 when the release fixture is removed or not present.

As noted above, the electronic device 200 can be a quadrilateral generally in which the front and back are parallel and the side surfaces are not parallel to one another. However, the general quadrilateral shape can include some additional vertical connecting surfaces to make at least two additional minor surfaces (i.e. substantially smaller vertical surfaces) 280 between the rear wall 206 and side walls 204 (as shown in FIG. 4).

Further disclosed is a method of making a printed circuit board to printed circuit board electrical connection or configuration 500 when a second printed circuit board 502 is positioned at a right angle to the primary printed circuit board 501. This can include the second PCB being connected behind the primary PCB on the component side 504 and the second printed circuit board being positioned on a non-component or bottom side 505 of the primary PCB. The connection for the two PCBs is through connector 503.

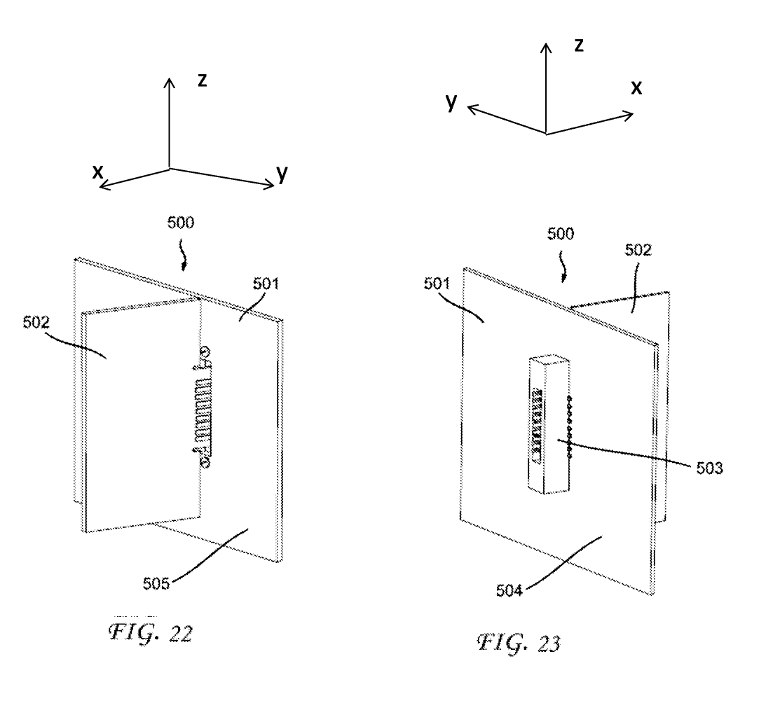

FIGS. 22-25 show perspective views of circuit board assembly configuration 500 which can be employed in the vertically oriented electronic device 200 to which the current principles are applied. The limited or small plan view cross-section area of the configuration 500 from the bottom view makes the configuration 500 commensurate with the screwless casing design of the vertically oriented electronic device 200. The reason is the plan view cross-section can effectively be a T-shape that can be positioned by design to avoid the screwless locking mechanism or vis-versa. Further, by having the antenna bracket 601 mounted in the finished product at heights in the device in which most of the antenna bracket 601 is above the top edge of the vertically oriented primary printed circuit board 501 makes the arrangement of the internal components further commensurate with the screwless casing design. With such an arrangement, the locking elements of the housing and the associated release fixture and release fingers for disassembly can be more freely positioned to avoid contacting or interfering with the printed circuit boards and/or other components. If one of the circuit boards were to be horizontally positioned, there would be less positions and greater constraints on the positioning of the locking elements of the housing and associated release fixture and release fingers. The circuit boards would need to be smaller and/or need to be positioned at higher locations with the device.

Since a component side 504 of PCB 501 can face a rear wall 206 of the housing of the electronic device, a problem is that access to the components on the component side 504 and access to a secondary PCB 502 may need to be made through an undesirable cable. Cables add cost and a point of potential failure. However, the connector 503 in FIG. 23 provides a way for the secondary PCB 502 to be directly attached to the primary PCB 501 in which the secondary PCB 502 is inserted into the connector 503. This arrangement reduces cost, improves quality and makes assembly easier, with fewer possibilities for assembly error.

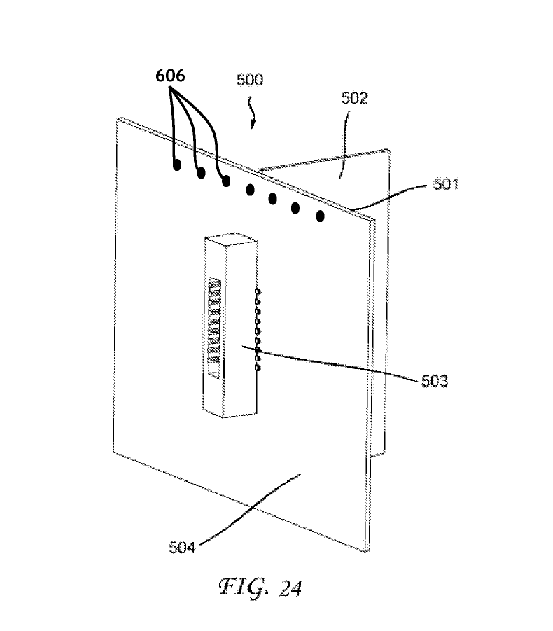

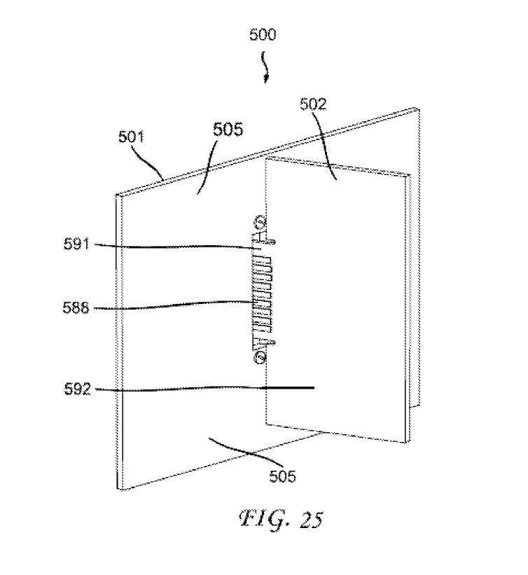

Because the PCB arrangement shown in FIGS. 22 and 23 reduces the number of cables, it makes room for the use of the plurality antenna cables or wires 604 needed to transmit antenna electrical signal within the device. As observed in FIG. 24, if the antenna connectors 606 are positioned near the top edge of the first printed circuit board 501, it is possible to have the antenna connectors 606 on the component side 504. As such, the antenna wires 604 can be short and the overall number of cables/wires within the device itself can be kept to a minimum number.

Also, having the connector 503 being elongated to run along the major axis adds stability to the support of second PCB 502 and such a configuration of the connector 503 being positioned in a central portion of the primary board 501 allows the second board 502 to fit more conveniently in the casing in which case top front piece 211 has a tapered shape in which the casing narrows to the front wall 208.

As shown in FIG. 25, in an embodiment, a portion of the second printed circuit board 502 includes an extension 591 of the second printed circuit board from a plane 592 that substantially abuts a surface of the second printed circuit board when the first printed circuit board 501 is connected to the second printed circuit board by the connector 503. Contacts 588 are arranged on the extension 591.

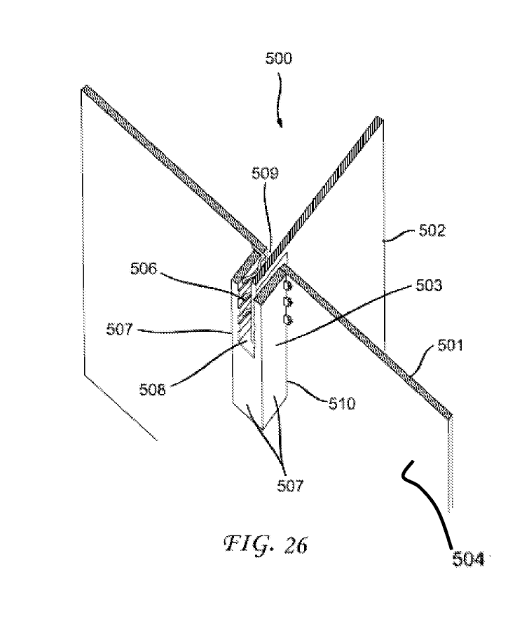

FIG. 26 is a cross sectional perspective view of a circuit board assembly configuration 500 highlighting the connector 503 and showing the contacts 506 that are on the interior cavity 508 of the connector 503 to which the current principles are applied. The connector 503 can be a rectangular structure having peripheral walls 507. The rectangular structure can have a leading edge 510 that can be a flange that faces the component side 504 of the PCB 501 and contacts the PCB 501 and a portion of the connector 503 that protrudes through aperture 509 in the first PCB 501. The connector 503 can extend back to the panel jack at the panel jack opening or can be connected to a cable running to the panel jack. The panel jack can be on the rear wall 206 of the electronic device or can be a part of the rear wall. The rear wall 206 can be part of the case top back piece 212 in which some of the lower rectangular features on the piece 212 in FIG. 11 can represent a panel jack.

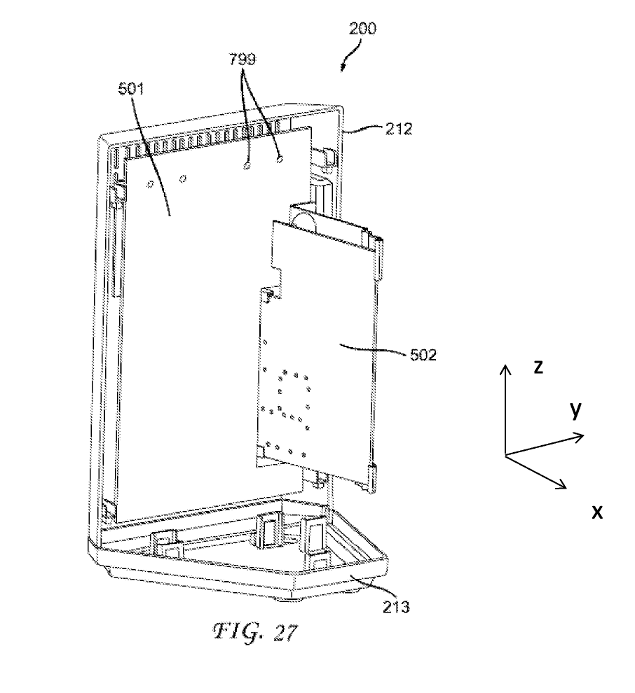

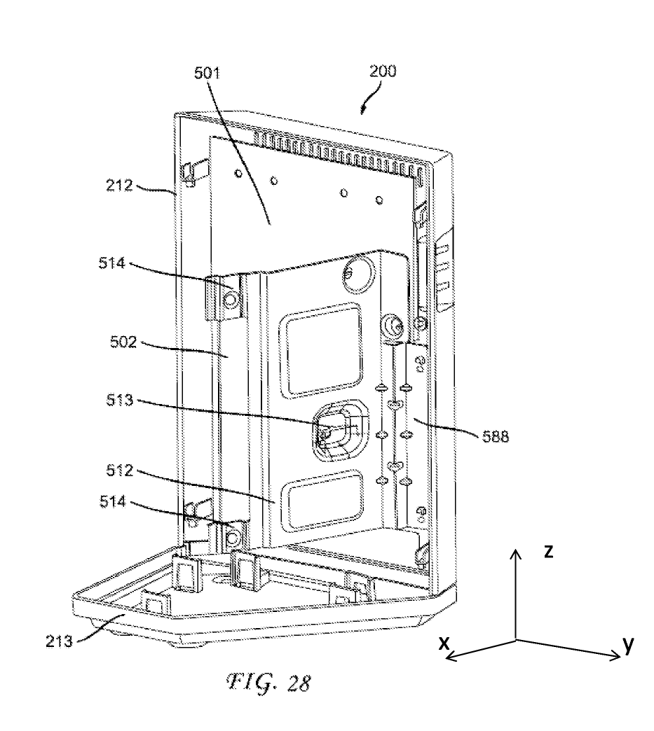

FIGS. 27-28 show interior perspective views of the vertically oriented electronic device 200 illustrating the circuit board assembly configuration 500 to which the current principles are applied. These views show that the primary PCB 501 can be screwed, bolted, or secured to the rear case or the case top back piece 212.

The view in FIG. 28 further illustrates that the secondary PCB 502 can have a heat spreader or heat sink 512 on one of its sides. The heat spreader or heat sink 512 can have a central contact portion 513 that thermally contacts the PCB 502 or heat generating components thereon. The spreader or sink 512 can have a planar peripheral portion that permits heat to be radiated or convected away from the PCB 502.

In an embodiment, the heat spreader or heat sink 512 can be generally parallel to the PCB 502 and both heat spreader or heat sink 512 and PCB 502 can be perpendicular to the PCB 501. The heat spreader or heat sink 512 can further provide structural support for the second PCB 502. Here, the heat spreader or heat sink 512 can have a base edge with a vertical ledge 588 that connects to the first PCB 501 or the case back 212 to support by the heat spreader 512 and in turn the heat spreader 512 support the second PCB 502 through contact points 514 (which can be screws or bolts or the like). The contact points 514 can work in conjunction with connector 503 to support the PCB 502. The contact points can run along an edge of the PCB 502 opposite the edge of PCB 502 having the base edge (support edge). Other mechanical connection features 799, such as screws or bolts, can secure the main board 501 to the electronic device 200.

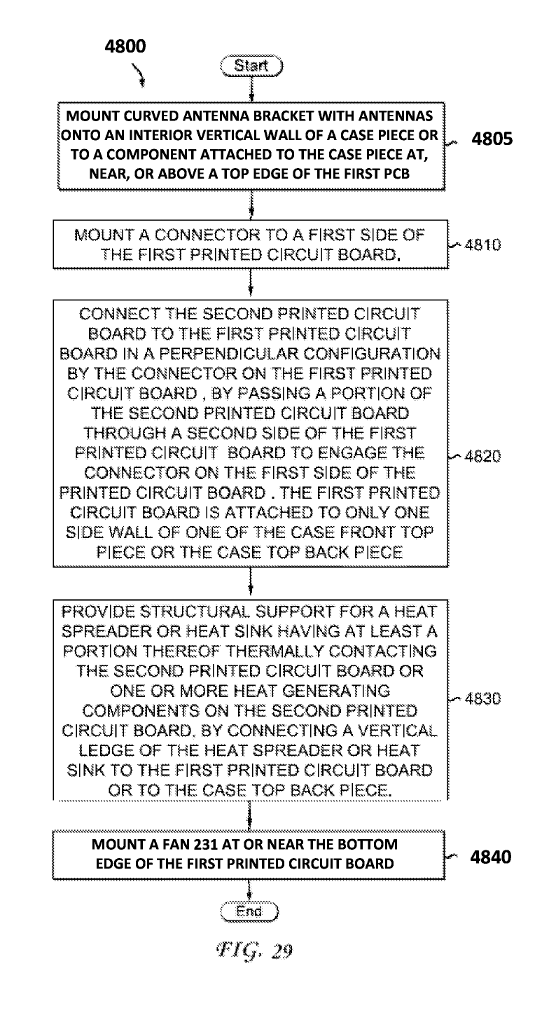

FIG. 29 shows an exemplary method 4800 for configuring multiple printed circuit boards in an electronic device 200 having a vertical orientation and having an antenna bracket, antennas, and an outer casing that includes a case bottom piece 213, a case top front piece 211 and a case top back piece 212 to which the current principles are applied. The multiple printed circuit boards include a first printed circuit board 501 and a second printed circuit board 502. Here, at step 4805, the antenna bracket 601, which can be a curved antenna bracket, which will be described below, is mounted onto an interior vertical wall of the case top front piece or case top back piece or mounted to a component that is mounted to the interior vertical wall of the case top front piece or case top back piece. This mounting can include the use of screws, bolts or the like. At step 4810, a connector 503 is mounted to a first side of the first printed circuit board 501. At step 4820, the second printed circuit board 502 is mounted to the first printed circuit board 501 in a perpendicular configuration 500 by the connector 503 on the first printed circuit board 501, by passing a portion of the second printed circuit board 502 through a second side of the first printed circuit board 501 to engage the connector 503 on the first side of the printed circuit board 501. The method can also include providing a structural support for a heat spreader or heat sink 512 having at least a portion thereof thermally contacting the second printed circuit board 502 or one or more heat generating components on the second printed circuit board 502, by connecting a vertical ledge of the heat spreader or heat sink 512 to the first printed circuit board 501 or to the case top back piece 212.

At step 4830, a structural support is provided for a heat spreader or heat sink 512 having at least a portion thereof thermally contacting the second printed circuit board 502 or one or more heat generating components on the second printed circuit board 502, by connecting a vertical ledge of the heat spreader or heat sink 512 to the first printed circuit board 501 or to the case top back piece 212.

At step 4840, a fan 231 can be positioned and mounted at or near the bottom edge of the first printed circuit board 501. The fan can concentrate a direct air flow upward past interior components and along interior edges of the bracket walls 603 and the hollow center of the antenna bracket 601.

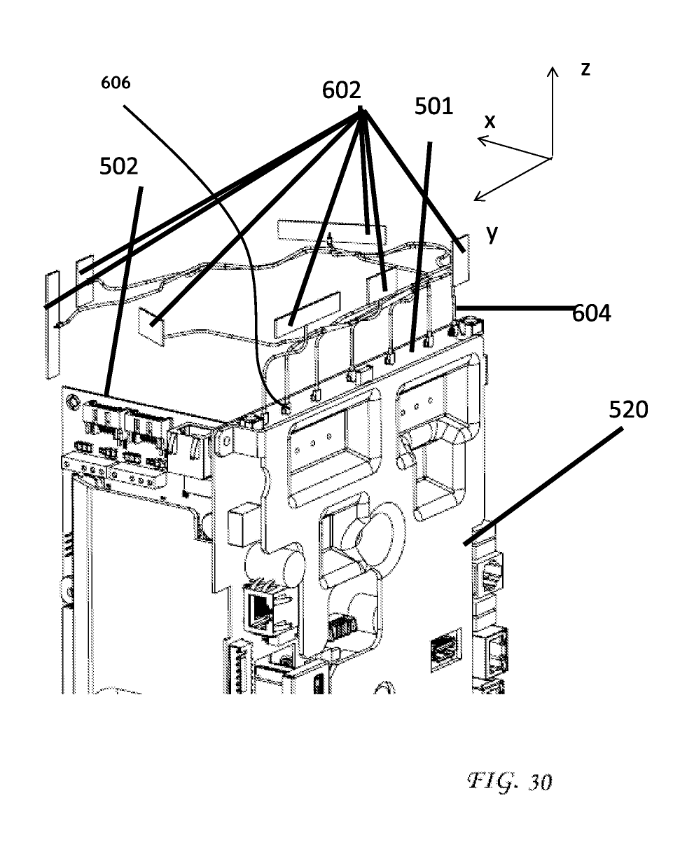

FIG. 30 shows the feature of the set top box without the case in which a plurality of antennas 602 are distributed over the printed circuit boards 501 and 502 and outside the peripheries of one or both of the orthogonally arranged printed circuit boards 501 and 502. An embodiment can include only one board and less than 7 antennas. Here, the first printed circuit board 501 with a board heat spreader and heat sink 520 (in which “board” refers to the heat sink or spreader being associated with the circuit board) is attached to one side of the first printed circuit board 501 that is opposite the side that connects to the second printed circuit board 502. The board heat spreader and heat sink 520 is between the first printed circuit board 501 and the rear wall 206 of the case top back piece 212 of the casing of the electronic device. The antennas 602 are connected to one of the circuit boards and, in this embodiment, are all attached to the first printed circuit board 501. The antennas 602 can be connected to the antenna connector 606 on the first printed circuit board 501 by way of the antenna wires 604. The antennas can be WIFI antennas and can be vertically oriented in the vertically oriented set top box as shown and positioned adjacent to the top 210 between the outer top peripheral edges of the printed circuit boards and the top 210 of the set top box. The antennas positioned along the rear wall 206 can be parallel to the rear wall 206 and laterally positioned to be between a vertical plane extending from the plane of the first printed circuit board 501 and the rear wall 206. The antennas 602 can be laminated antenna printed circuit boards.

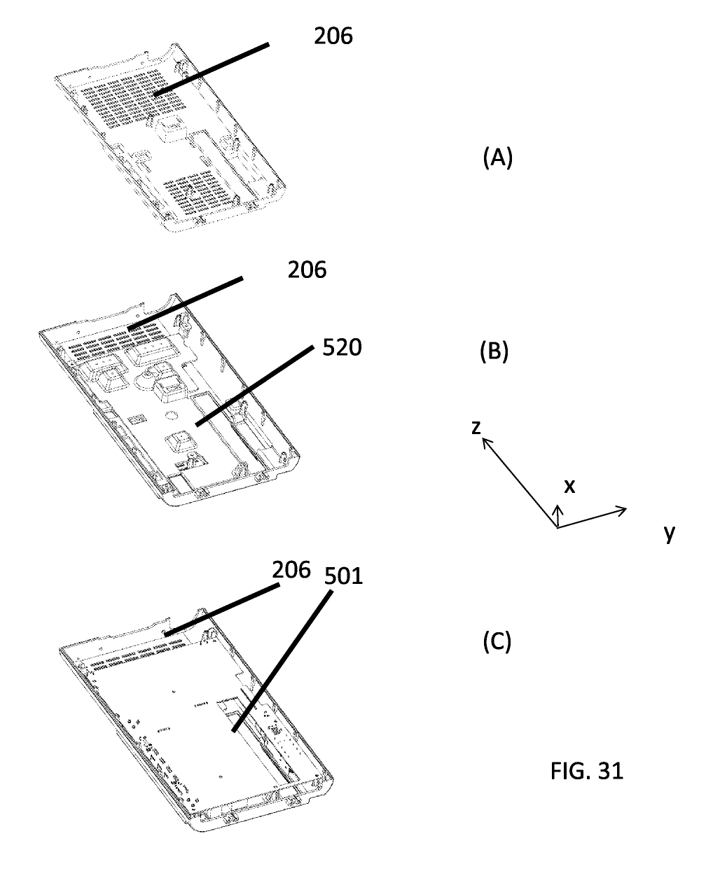

FIG. 31A shows the rear wall 206 of the case top back piece 212 that is omitted in FIG. 30. FIG. 31B shows the board heat spreader and/or heat sink 520 positioned adjacent to the rear wall, and FIG. 31C shows the first printed circuit board 501 which is connected to the board heat spreader and/or heat sink 520 thereover.

Inspection of FIG. 30 shows that interior volume of vertically oriented electronic devices can be quite crowded with a complex arrangement of components that comprise circuit boards, the components on the circuit boards, and the components to which the circuit board components are physically or electronically connected. This crowdedness and complexity is further enhanced when a plurality of antennas is need, because the conventional arrangement of the antennas involves having its own independent support. This, in turn, adds to the number of interior components that must be individually staged, isolated from other components and installed. Further, in these vertically oriented electronic devices, it turns out that there are spatial constraints and inefficiencies with the individual supports. In other words, the need for rapid assembly in high volume factories makes it difficult to manufacture such devices in which the antennas are individually supported with their own supports.

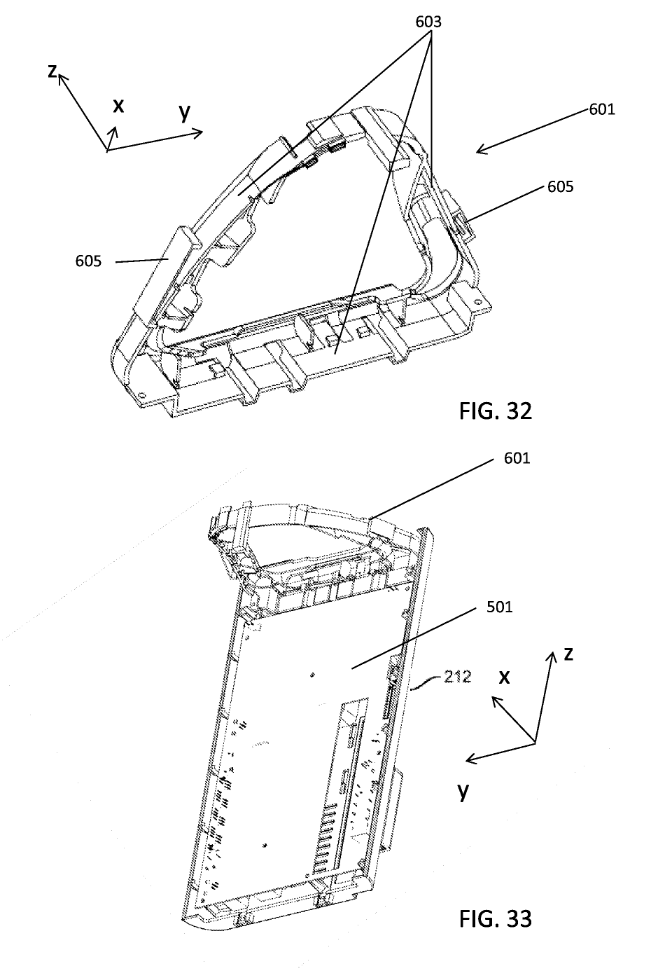

In view of the above mentioned issues with individual supports and the need to shield antennas, a single unitary antenna bracket 601 is provided and shown in FIG. 32 for holding the plurality of the antennas 602 that were presented in FIG. 30.

This perspective view shows the antenna bracket 601 that holds multiple antennas and antenna wires 604. The antenna bracket includes multiple bracket walls or sides 603 to form a polygon structure and antenna pockets 605 supported on at least two bracket walls, wherein the antennas fit within the pockets and the pockets prevent electrostatic discharge to and/or from the antennas. The antenna bracket 601 can have rounded corners and the sides 603, and the corners can follow or generally follow the interior contour of the vertical walls of the casing. FIG. 33 show a rear perspective view of the antenna bracket 601 in relation to the printed circuit board 501.

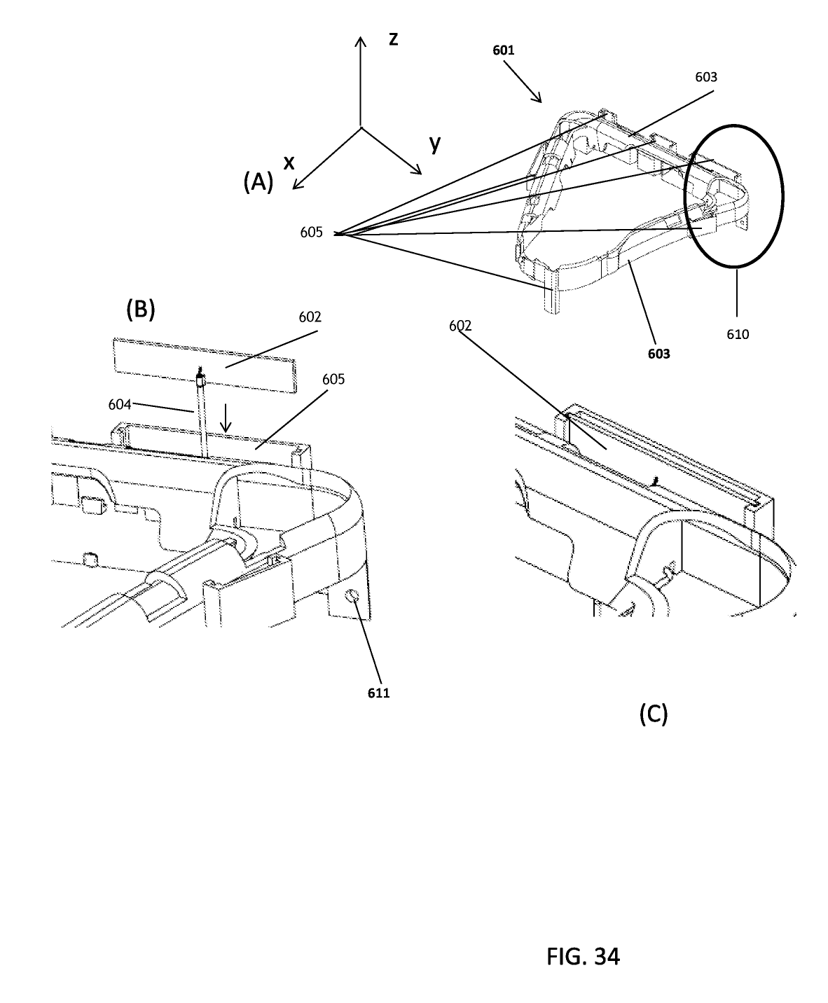

FIG. 34 shows various perspective views of the antenna bracket 601 and how the antennas 602 slide into the pockets 605. In particular, the corner region 610 of the bracket 601 highlighted in FIG. 34A is enlarged in FIGS. 34B and 34C to show how the antenna 602 can be inserted into and supported by the pockets 605. The pockets 605 have a hollow structure with two broad walls parallel to the broad surfaces of the antenna and two openings. The pockets can further include two narrow opposing end walls that bridge the two broad walls. One opening can be at the top for the antenna to slide into and another opening at the bottom for the antenna wire 604 to extend through to connect preferably to one of the printed circuit boards.

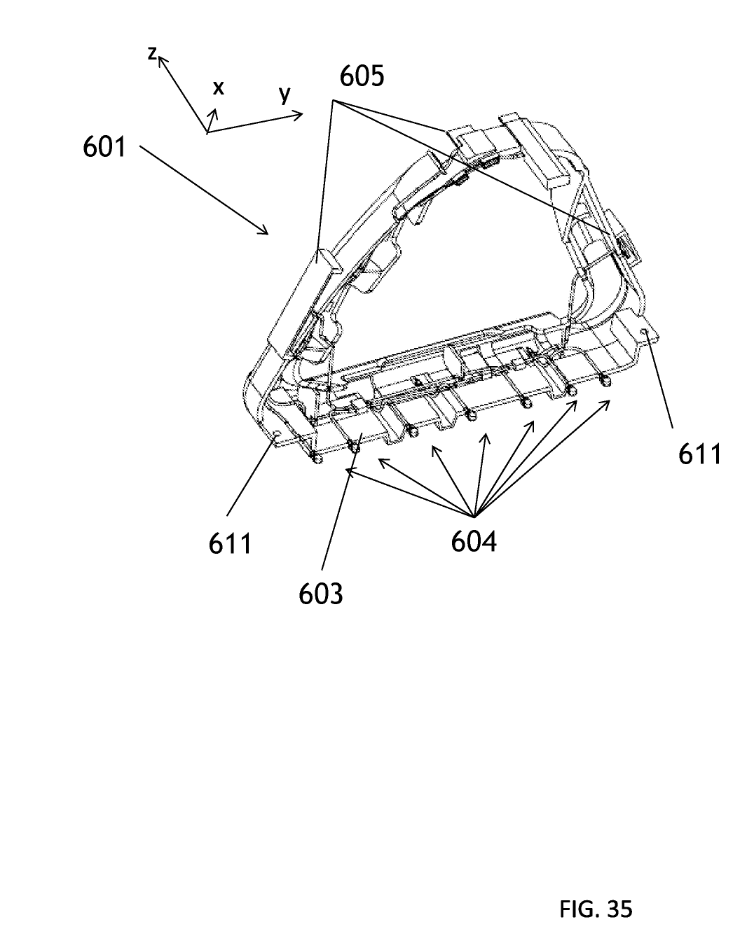

FIG. 35 shows a perspective view of the antenna bracket 601 and how the antenna wires 604 can be routed to one bracket wall 603. This view along with the view in FIG. 30 shows that the antenna wires 604 can be routed from end of the antenna pockets 605 along the bracket walls 603 toward one of the bracket walls 603 and downward toward the antenna connector 606. Also, FIG. 35 and FIG. 34 show that the antenna bracket 601 can have mounting apertures 611 on at least one of its walls 603 to secure the bracket 601 to a wall of the housing of the electronic device or to a printed circuit board.

FIG. 36 shows a perspective view of the antenna bracket 601 and how the antenna wire 604 can be routed to one bracket wall 603 and down to the first printed circuit board 501 between the first printed circuit board 501 and the rear wall 206. The wires 604 can connect to connectors 606 at the edge of the first printed circuit board 501. This view shows that the bracket 601 and the printed circuit board can both be attached to the same wall 206 of the housing of the device.

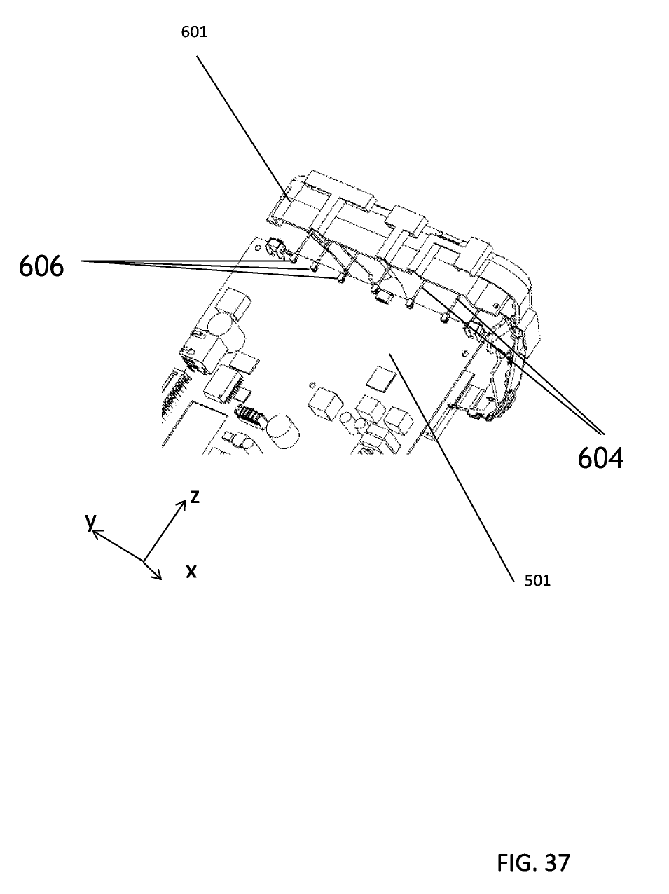

FIG. 37 shows a rear perspective view of the antenna bracket 601 and how the antenna wire 604 can be routed to one bracket wall 603 and down to the first printed circuit board 501 and connect to antenna connector 606 at the edge of the first printed circuit board 501. This view shows that the bottom edge of the bracket wall 603 to which each of the wires 604 are routed can be separated from the top edge of the printed circuit board 501 to which the wires 604 are routed.

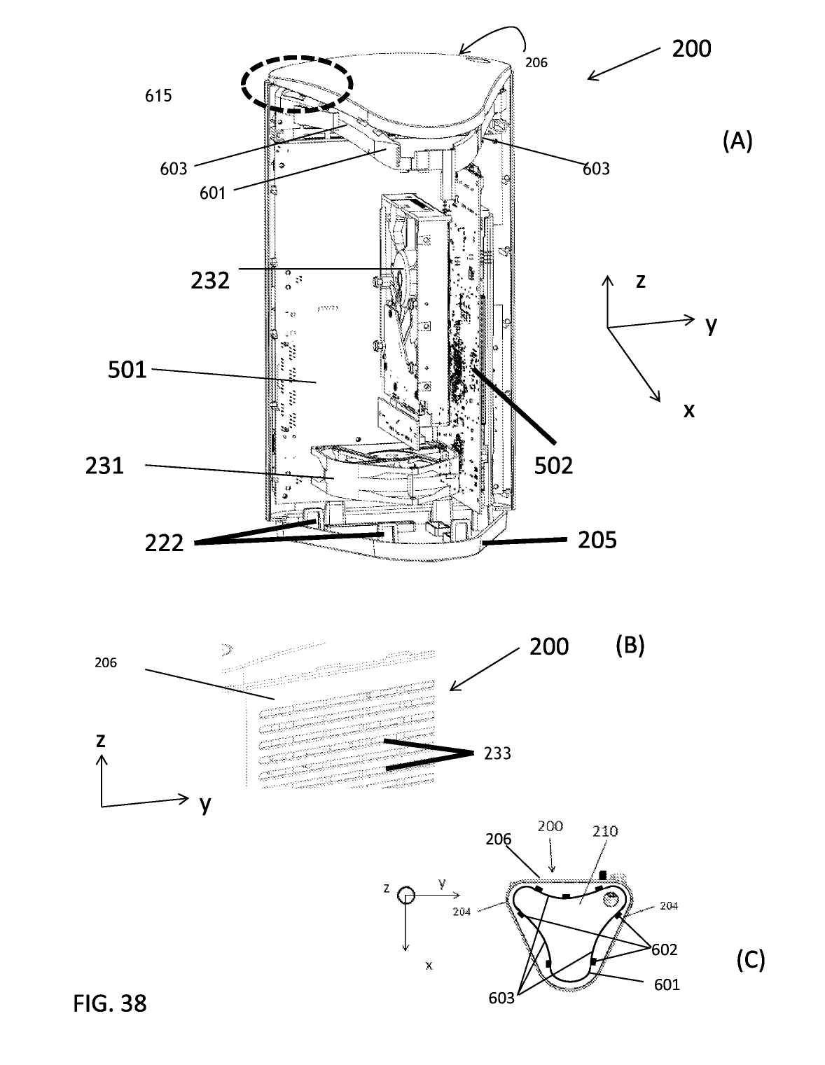

Regarding heat management, even with a plurality of heat sinks and/or heat spreaders that have thus far been disclosed in the various embodiments of this disclosure, heat management still remains challenging and overheating within the vertically oriented set top boxes and remains a concern due to the plurality of contents and functionalities. As such, some additional implementations, which have been suggested with reference to FIG. 29, have been developed and are shown in FIG. 38A. The electronic device 200 in addition to the possible components and features already described can include the antenna bracket 601 being a curved antenna bracket. This can mean that at least one of the multiple bracket walls 603 which form a polygon structure is curved from a top plan perspective such that a concave side faces a corresponding vertical wall 204, 206 of the casing. The curvature in this case refers to the bracket sides 603 and not the corners of the bracket. In this case, the antenna pockets 605 can still be supported on at least two bracket walls 603, wherein antennas 602 fit within pockets 605 and the pockets still prevent electrostatic discharge to and/or from the antennas. The curved antenna bracket 601 can have rounded corners. The device can include a fan 231 positioned at a lower position than the antenna bracket 601. The fan can be attached to either printed circuit board 501, 502 on the low half of the printed circuit board and above the clip engaging features 222 of the base 205 of the casing such that the fan 231 is above the locking mechanism and does not interfere with the locking and unlocking of the casing. The fan 231 can be positioned horizontally to force air upward from its blades. The electronic device can include vents 233 on the exterior vertical walls positioned adjacent to the antennae and can include some vents at the same height of the bracket and antennae. Also, in this design, another heat generating component 232 can be attached to one side of the second printed circuit board 502. The component can be vertically oriented and can be a hard drive.

FIG. 38B shows an exterior view of the rear wall 206 from an area highlighted in region 615 in FIG. 38A. FIG. 38B shows vents 233 that work in concert with the fan 231 to assist in expelling heated air out of the device 200. The vents 233 can be open in the vicinity of the antennas 602 or at the same lateral height of the antennas 602, because the pockets can protect (what?) from the electrostatic discharge associated with the antenna. The features in FIG. 38B are in contrast to some set top boxes in which some apparent vents in the vicinity of antennas are false vents intended to decorative such that they are closed to avoid electrostatic discharge.

FIG. 38C shows a top plan view highlighting the feature of the antenna bracket 602 being a curved antenna bracket from a top plan view perspective in which the bracket walls 603 are curved or bowed to be concave with respect to the vertical walls 204, 206 as mentioned above.

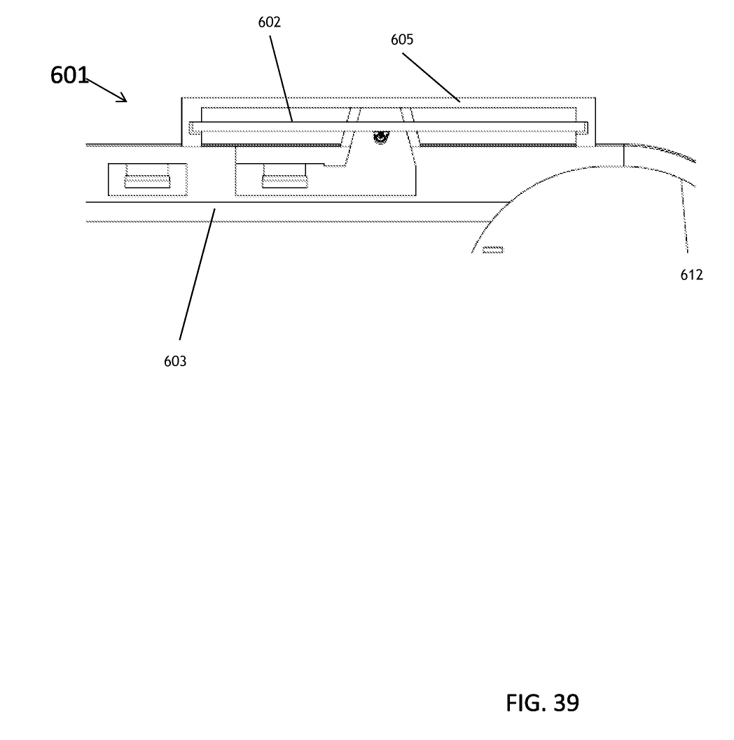

FIG. 39 shows a magnified top view of a portion of the antenna bracket 601 near a corner 612 of the bracket 601. This view shows how the antennas 602 can be positioned and supported within the antenna pockets 605. The pockets 605 can themselves be supported on the exterior sides of the bracket walls 603. The pockets 605 can have two elongated parallel walls that are parallel to the antenna 602 and separated from the antenna 602 to form air gaps that promote air circulation and cooling of the antenna. Further, the pockets 605 can have two narrow parallel walls perpendicular to the antenna in which the narrow parallel walls can have antenna supporting slots for edges of the antenna 602 to fit.

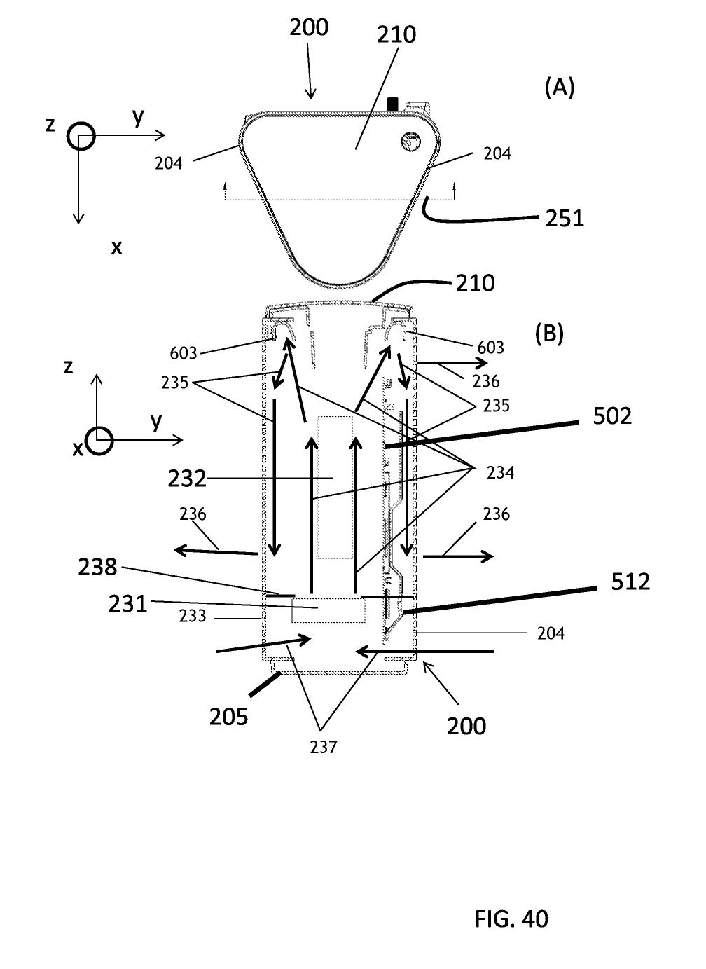

FIG. 40A shows a top plan view of the device 200 and FIG. 40B shows a sectional interior view of the device 200 in FIG. 40A cut along a vertical section 251 which is parallel to the y-z plane. FIG. 40B shows that the curved bracket wall 603 can have a bent frame structure in which the bracket walls 603 include a U-shape with the open end facing downward and toward the fan. In other words, the curved antenna bracket can alternatively mean that the curved sides are curve from a vertical cross section perspective instead of or in addition to the plan view perspective curvature shown in FIG. 38C. The antenna pockets 605 (not shown) can be position on the outer long side of the U-shape sectional profile. The U-shape sectional profile can direct air flow from the interior regions of the device and/or the printed circuit boards 501, 502 downward and/or outward to between the printed circuit board 502 and an adjacent vertical wall 204 of the housing and between the heat sink 512 and the adjacent vertical side wall 204. With the assistance of the vents 233 positioned all along the vertical side walls 204 and the fan 231 positioned in the lower half of the device 200, inwardly directed air 237 enters the device 200 through vents 233 positioned at heights lower than the fan 231. The air is then urged into upwardly direct air 234 above the fan. This upwardly direct air 234 is cooling air and can pass various components which can include heat generating component 232 to remove heat therefrom as it is direct toward the top 210 and the antenna bracket. Some portion of the upwardly direct air 234 can then be urged and steered into downwardly directed air 235 and/or outwardly directed air 236 by the U-shape of the bracket walls 603. The downwardly directed air 235 and outwardly directed air 236 flow, respectively, along the vertical wall 204 of the housing and out of the device 200 through vents 231 in the vertical walls 204 to enhance cooling. This cooling can include heat removal from the side of the printed circuit board facing the adjacent vertical wall 204, 206 and the heatsink 512 thereon.

The device 200 can include a partition 238 to separate inlet air, which can be the inwardly directed air 237, from the main body region, which can be the region of the device 200 above the fan 231.

The implementation of the features shown and described in FIGS. 38-40 provides for a heat controlled set top box that sits vertically which can support the use of 7 WIFI antennas spaced in various positions around the top of the set top box.

The principles further protect the antennas from electrostatic without blocking vents and without the need to increase the interior volume of the casing. The reason is the air currents caused by use of the current principles allow or can compensate for some degree of crowding of the components and the antenna pocket design does not require some vents to be closed or eliminated and does not require the vertical walls to be moved further outward or to be further spaced from the antennas.

With the WIFI antenna wires being routed and held in place, the fan can be mounted towards the bottom of the device to cause air to blow upward during operating in which the fan can supply air to multiple printed circuit boards and a hard drive. The fan 231 can be horizontal and perpendicular to the printed circuit boards and/or can be below the hard drive 232. The fan can be positioned at a vertical level such that it overlaps at least one printed circuit board.

With regards to FIG. 38C, which was briefly described above, this view shows how the curved bracket walls 603 provide some additional air flow passageway, which can be some additional space between the vertical walls 204, 206 and the bracket walls 603. Essentially, the concavity permits some additional upward air to exit through the vents near and/or at the same height as the bracket, and the curved interior shape, i.e. the U-shape, of the bracket wall directs some cooling air downward as described above to interior sides of the casing walls to go between the interior walls and the components adjacent thereto. Additionally, the curved exterior top surface of the U-shape profile promotes air circulation between the bracket walls and over the bracket walls. The curved interior surface of the U-shape profile also promotes air circulation by being smooth.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope of the present principles. All such changes and modifications are intended to be included within the scope of the present principles. For example, although the embodiments generally refer to the components with a vertically oriented electronic device in which the vertical height of the device can be greater than the horizontal length of each of the side walls, the principles are intended to be useful and are intended to include horizontally oriented electronic device.

Additionally, although the sides of the vertically oriented electronic device as well as other components are characterized as being “vertical” or “vertically oriented,” it should be understood that these expression are intended to include surfaces which may have some curvature or some small deviations from being completely vertical (e.g. +/−10° from vertical can be considered vertical).

Also, it is intended that the expressions “rear” and “front,” the expressions “top” and “bottom,” and the expressions “vertical” and “horizontal,” as well as other complementary terms are intended to be construed from the perspective of the observer of the figures; and as such, these expression can be interchanged depending upon the direction that the observer observes the device.

1. An electronic device for vertical orientation when in operation, comprising:
a plurality of vertically oriented walls;
an antenna bracket having at least two sides that support antennas which extend from corners of the antenna bracket, at least one of the sides of the antenna bracket having a curved profile, the curved profile comprising a U-shape cross section with an open end facing downward; and
a horizontally oriented fan positioned closer to a base of the electronic device than to a top of the electronic device, wherein the fan is positioned below the antenna bracket and is oriented to force air upward and into at least the interior half of the U-shape cross section, the U-shape cross section directing some upwardly directed air to travel downward between interior components of the electronic device that are adjacent to the at least one of the vertically oriented walls.

2. The electronic device of claim 1, wherein the at least one of the sides is positioned adjacent to a corresponding one of the vertically oriented walls, the vertically oriented walls being planar.

3. The electronic device of claim 1, wherein:
the at least one of the sides is vertically oriented along a corresponding one of the vertically oriented walls; and
the at least one of the sides is bowed from a top plan view perspective to have a concave side facing the corresponding vertically oriented wall of the electronic device.

4. The electronic device of claim 3, further comprising a plurality of antenna connectors positioned away from the antenna bracket and configured to connect with a plurality of antenna wires extending from each of the antennas.

5. The electronic device of claim 4, further comprising a vertically oriented printed circuit board positioned at least partially below the antenna bracket, wherein the antenna connectors are positioned adjacent to a top edge of the printed circuit board.

6. The electronic device of claim 5, wherein the printed circuit board is vertically oriented and is parallel to the first wall of the vertically oriented walls.

7. The electronic device of claim 6, further comprising a fan positioned on the printed circuit board, wherein the fan is oriented to force air upward and through a hollow center region of the antenna bracket.

8. The electronic device of claim 7, further comprising vents in at least one of the vertically oriented walls, wherein some of the air through the hollow center region of the antenna bracket is redirect by or at a top of the electronic device to pass over the sides of the antenna bracket and downward along the vertically oriented walls and outward through the vents.

9-10. (canceled)

11. The electronic device of claim 1, further comprising vents in at least one of the vertically oriented walls, wherein the U-shape cross section directs some upwardly directed air to travel downward between interior components of the electronic device that are adjacent to the at least one of the vertically oriented walls and to travel outward through at least some of the vents.

12-13. (canceled)

14. The electronic device of claim 1, further comprising vents in at least one of the vertically oriented walls, wherein portions of the upwardly directed air is directed through an additional air passageway formed by a concavity between the vertically oriented walls and the antenna bracket and the vents.

15. (canceled)

16. The electronic device of claim 1, further comprising a vertically oriented hard drive positioned above the fan and below the antenna bracket.

17. The electronic device of claim 1, wherein the electronic device is a vertically oriented set top box or a vertically oriented gateway device that further comprises;
a vertically oriented printed circuit board positioned below the antenna bracket.

18. (canceled)

19. The electronic device of claim 1, wherein the antennas are vertically oriented and the antenna bracket comprises antenna pockets, the antenna pockets each having an opening into which one of the antennas is inserted for support.

20. (canceled)
